(19) United States
(12) Patent Application Publication
(10) Pub. No.: US 2015/0381761 A1
(43) Pub. Date: Dec. 31, 2015

(54) METHODS AND APPARATUS FOR REQUESTING USER SPECIFIC POLICY INFORMATION FOR LOCAL APPLICATIONS

(71) Applicant: NOKIA SOLUTIONS AND NETWORKS OY, Espoo (FI)

(72) Inventors: Mikko Tapani SUNI, Espoo (FI); Roland Antonius WOELKER, Espoo (FI); Tommy Johannes LINDGREN, Espoo (FI)

(21) Appl. No.: 14/772,112

(22) PCT Filed: Mar. 11, 2013
(86) PCT No.: PCT/EP2013/054839

§ 371 Date: Sep. 2, 2015

(51) Int. Cl. H04L 29/08; H04L 12/46; H04W 4/00; H04L 12/14; H04L 29/12

(52) U.S. Cl. CPC H04L 67/32; H04L 67/10; H04L 12/1407; H04L 61/2007; H04W 4/003; H04L 12/4633

(57) ABSTRACT

A method comprises sending a request from an application server functionality, providing a local application functionality to a user equipment, to a policy server functionality, said policy server functionality storing local application policy information for said user equipment, and receiving information from said policy server functionality about said local application policy in formation for said user equipment.

Some embodiments relate to methods and apparatus and in particular but not exclusively to methods and apparatus and in particular but not exclusively to methods and apparatus for use in conjunction with application policy information.

A communication system can be seen as a facility that enables communications between two or more entities such as a communication device, e.g. mobile stations (MS) or user equipment (UE), and/or other network elements or nodes, e.g. Node B or base transceiver station (BTS), associated with the communication system. A communication system typically operates in accordance with a given standard or specification which sets out what the various entities associated with the communication system are permitted to do and how that should be achieved.

Wireless communication systems include various cellular or other mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN) and the GSM/EDGE radio access network (GERAN).

A geographical area covered by a radio access network is divided into cells defining a radio coverage provided by a transceiver network element, such as a base station or Node B. A single transceiver network element may serve a number of cells. A plurality of transceiver network elements is typically connected to a controller network element, such as a radio network controller (RNC).

A user equipment or mobile station may be provided with access to applications supported by the core network via the radio access network. In some instances a packet data protocol (PDP) context may be set up to provide traffic flows between the application layer on the user equipment and the application supported by the core network.

According to an aspect, there is provided a method comprising; sending a request from an application server functionality, providing a local application functionality to a user equipment, to a policy server functionality, said policy server functionality storing local application policy information for said user equipment; and receiving information from said policy server functionality about said local application policy information for said user equipment.

The method may comprise at least one of sending said request and receiving said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

The method may comprise storing said information from said policy server functionality about said local application policy information for said user equipment information in said application server functionality.

The stored information may have a validity period associated therewith.

The method may comprise using tunnelling between said application server and said policy server functionality to communicate at least one of said request and said information therebetween,

The method may comprise using tunnelling between said application server and said policy functionality to communicate one of said request and said information therebetween and a different path to communicate the other of said request and information between the application server and said policy server functionality.

According to an aspect, there is provided a method comprising; receiving a request from an application server functionality, providing a local application functionality to a user equipment, at a policy server functionality, said policy server functionality storing local application policy information for said user equipment; and providing information from said policy server functionality to said application server functionality about said local application policy information for said user equipment.

The method may comprise at least one of receiving said request and sending said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

The method may comprise using tunnelling between said application server and said policy server functionality to communicate at least one of said request and said information therebetween,

The method may comprise using tunnelling between said application server and said policy functionality to communicate one of said request and said information therebetween and a different path to communicate the other of said request and information between the application server and said policy server functionality.

According to an aspect, there is provided a method comprising: receiving, at a policy server functionality, identity information associated with a user equipment: and responsive to said information obtaining from a further entity policy information for said user equipment.

The further entity may comprise one or more of a PCRF, a radius server, a database and an LDAP server.

The identity information may comprise an IMSI and/or IP address.

According to another embodiment, there is provided an apparatus which is configured to perform the previous method (s).

A computer program comprising program code means adapted to perform the method(s) may also be provided. The computer program may be stored and/or otherwise embodied by means of a carrier medium.

According to an aspect, there is provided an apparatus comprising; means for sending a request from an application server functionality, providing a local application functionality to a user equipment, to a policy server functionality, said policy server functionality storing local application policy information for said user equipment; and means for receiving information from said policy server functionality about said local application policy information for said user equipment.

At least one of said sending means and said receiving means is for sending said request and/or receiving said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

The apparatus may comprise means for storing said information from said policy server functionality about said local application policy information for said user equipment information in said application server functionality.

The stored information may have a validity period associated therewith.

At least one of the sending and receiving means is for using tunnelling between said application server and said policy server functionality to communicate at least one of said request and said information therebetween,

At least one of the sending and receiving means is for using tunnelling between said application server and said policy functionality to communicate one of said request and said information therebetween and a different path to communicate the other of said request and information between the application server and the policy functionality.

According to an aspect, there is provided an apparatus comprising: means for receiving a request from an application server functionality, providing a local application functionality to a user equipment, at a policy server functionality, said policy server functionality storing local application policy information for said user equipment; and means for providing information from said policy server functionality to said application server functionality about said local application policy information for said user equipment.

At least one of said sending means and said receiving means is for receiving said request and/or sending said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

At least one of the providing and receiving means may be for using tunnelling between said application server and said policy server functionality to communicate at least one of said request and said information therebetween,

At least one of the providing and receiving means may be for using tunnelling between said application server and said policy functionality to communicate one of said request and said information therebetween and a different path to communicate the other of said request and information between the application server and the policy functionality.

According to an aspect, there is provided an apparatus comprising: means for receiving, at a policy server functionality, identity information associated with a user equipment: and responsive to said information obtaining from a further entity policy information for said user equipment.

The further entity may comprise one or more of a PCRF, a radius server, a database and an LDAP server.

The identity information may comprise an IMSI and/or IP address.

According to another embodiment, there is provided an apparatus comprising at least one processor and at least one memory including computer code for one or more programs, the at least one memory and the computer code configured, with the at least one processor, to cause the apparatus at least to: send a request from an application server functionality, providing a local application functionality to a user equipment, to a policy server functionality, said policy server functionality storing local application policy information for said user equipment; and receive information from said policy server functionality about said local application policy information for said user equipment.

The at least one memory and the computer program code may be configured to, with the at least one processor to send said request and/or receive said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

The at least one memory and the computer program code may be configured to, with the at least one processor to store said information from said policy server functionality about said local application policy information for said user equipment information in said application server functionality.

The stored information may have a validity period associated therewith.

The at least one memory and the computer program code may be configured to, with the at least one processor use tunnelling between said application server and said policy server functionality to communicate at least one of said request and said information therebetween,

The at least one memory and the computer program code may be configured to, with the at least one processor use tunnelling between said application server and said policy functionality to communicate one of said request and said information therebetween and a different path to communicate the other of said request and information between the application server and the policy functionality.

According to another embodiment, there is provided an apparatus comprising at least one processor and at least one memory including computer code for one or more programs, the at least one memory and the computer code configured, with the at least one processor, to cause the apparatus at least to: receive a request from an application server functionality, providing a local application functionality to a user equipment, at a policy server functionality, said policy server functionality storing local application policy information for said user equipment; and provide information from said policy server functionality to said application server functionality about said local application policy information for said user equipment.

The at least one memory and the computer program code may be configured to, with the at least one processor to receive said request and/or send said information via tunnelling between said application server functionality and said policy server functionality.

The information about said local application policy information for said user equipment may comprise one or more rules to be applied to said user equipment.

The information about said local application policy information for said user equipment may comprise information identifying one or more rules stored in said application server functionality.

The application server functionality may be provided in a radio access network.

The at least one memory and the computer program code may be configured to, with the at least one processor use tunnelling between said application server and said policy server functionality to communicate at least one of said request and said information therebetween,

The at least one memory and the computer program code may be configured to, with the at least one processor use tunnelling between said application server and said policy functionality to communicate one of said request and said information therebetween and a different path to communicate the other of said request and information between the application server and the policy functionality.

According to another embodiment, there is provided an apparatus comprising at least one processor and at least one memory including computer code for one or more programs, the at least one memory and the computer code configured, with the at least one processor, to cause the apparatus at least to: receive, at a policy server functionality, identity information associated with a user equipment: and responsive to said information obtain from a further entity policy information for said user equipment.

The further entity may comprise one or more of a PCRF, a radius server, a database and an LDAP server.

The identity information may comprise an IMSI and/or IP address.

In the above, many different embodiments have been described. It should be appreciated that further embodiments may be provided by the combination of any two or more of the embodiments described above.

Embodiments are described below, by way of example only, with reference to the accompanying drawings, in which:

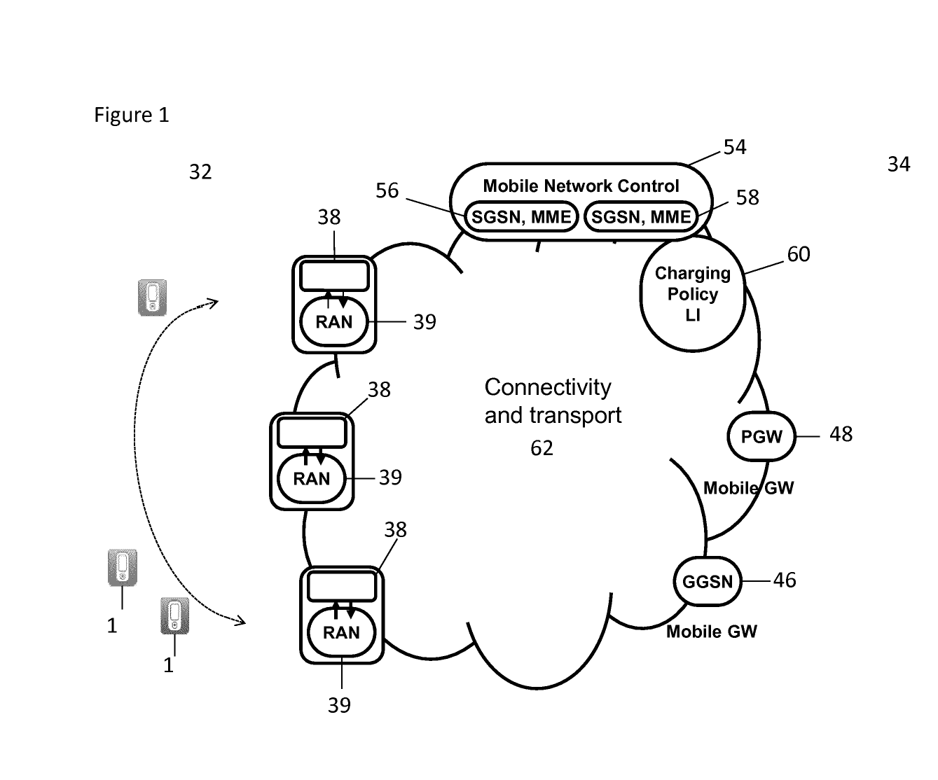

FIG. 1 shows a schematic general overview of a radio access network and a core network according to some embodiments;

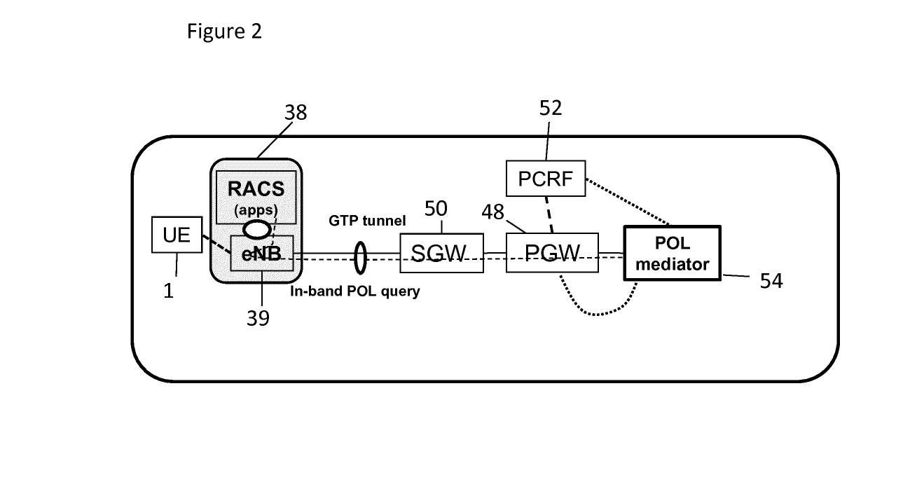

FIG. 2 shows a schematic view of some embodiments;

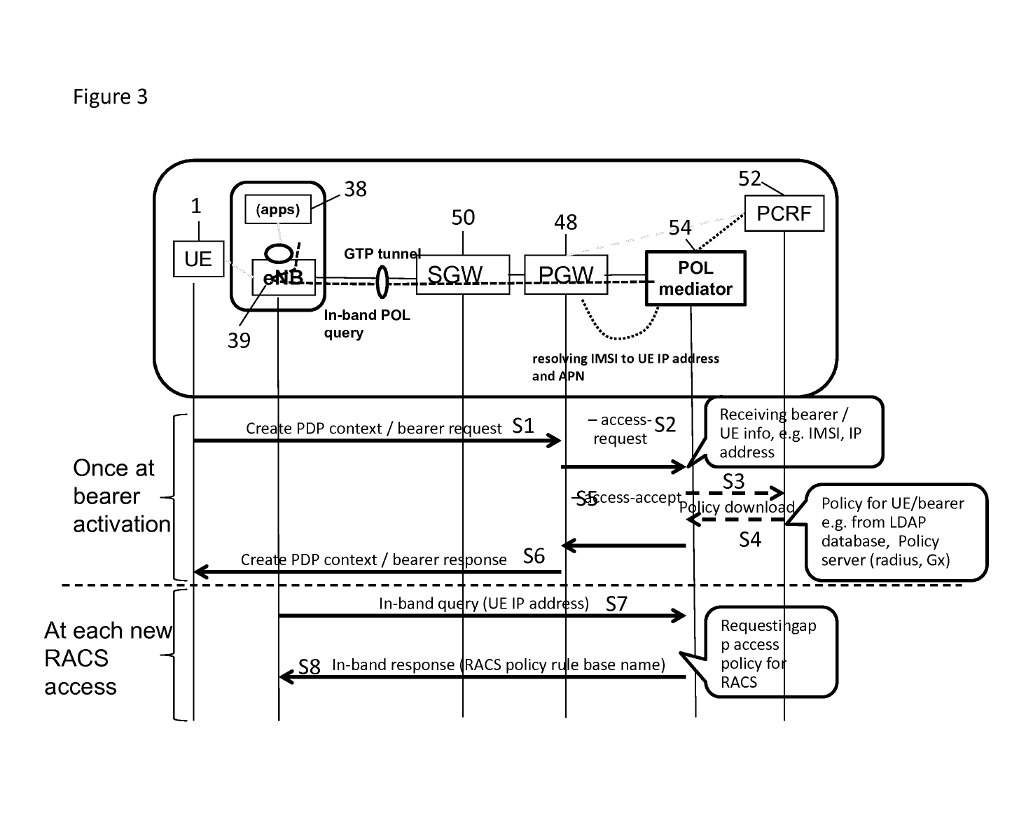

FIG. 3 shows a message flow of some embodiments: and

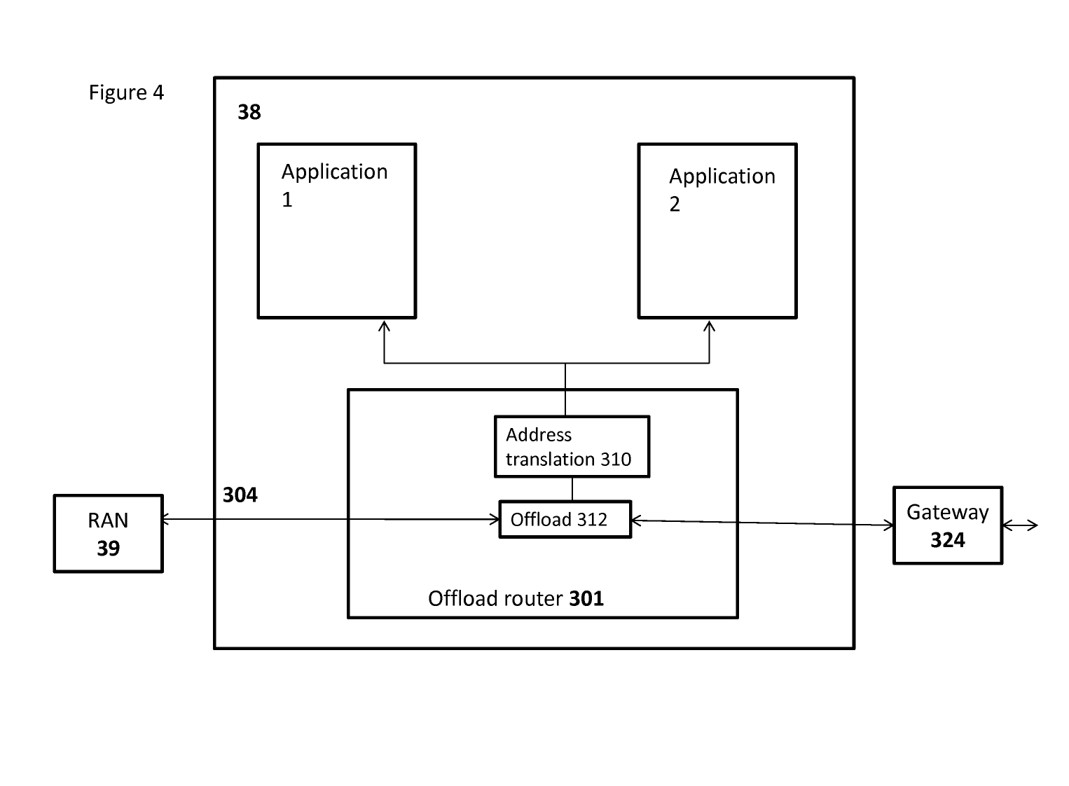

FIG. 4 schematically shows an application server function.

Embodiments may be used where there are local break out and off load solutions. This may be in the context of a 3GPP radio environment or any other suitable environment. In some embodiments, applications may be deployed to offload points using for example cloud style application deployments.

Local breakout function may provide a mechanism to serve traffic by local applications. In other words, Internet content or the like is brought to a local breakout point. There are many use cases of localization. By way of example, this may be one or more of a local content delivery network (CDN), local transparent caching, local content optimization for a mobile terminal and/or network, local hosting of other kind of services (used by mobile terminals), and local serving of machine-to-machine (M2M) terminals, for example aggregation functions or the like.

Local breakout may be applied alternatively or additionally to other types of radio networks, such as Wi-Fi, WiMax and Femto network. In such embodiments the offload may be between core network and Internet transit/peering.

Some embodiments may integrate a server module or function into the RAN (Radio Access Network). This application server function may be considered to be a RAGS (Radio Applications Cloud Server). It should be appreciated that this application server function may be a cloud server or any other suitable server. The RAN may be provided by one or more entities. In some embodiments, the RAN may comprise a BTS (base transceiver station) to which an RNC (radio network controller) has been integrated or RNC in a 3G networks, or an eNB (enhanced Node B) in LTE (Long term evolution). It should be appreciated that other embodiments may alternatively or additionally be used in conjunction with any other suitable standard or system.

The application server function may enable the deployment and hosting of local applications at the RAN side in a virtualization computing environment and applying cloud technologies. The “leaky bearer” offload concept may be applied to gain access to the mobile bearer traffic flows. The traffic flows may be IP traffic flows. By way of example the IP traffic flows may comprise one or more of PDP (packet data protocol) context and EPS (evolved packet system) bearer.

Local breakout scenarios are specified in 3GPP release 10 under the name SIPTO (selected IP traffic offload). One of the concepts for 3G networks is the so-called “leaky bearer” traffic flow break-out, also called TOF (Traffic offload). It allows extracting or inserting IP flows of an existing mobile bearer based on activated IP flow traffic filters. This is a flexible break-out concept without involvement of or impact on the UE (user equipment). The concept provides local access to mobile bearer traffic flows and in this way is used for the deployment and execution of applications at the RAN like CDN (content delivery network) solutions, content delivery optimization, caching solutions or others. These local applications may benefit from the proximity to the radio (e.g. location awareness, lower latency) and of having access to radio information, e.g. radio cell load, location, UE's specific radio condition.

It should be appreciated that some embodiments may alternatively or additionally use different local breakout techniques other than those discussed above.

Reference is now made to FIG. 1 which shows one example of a schematic architecture. In this example, an application server function 38 may be integrated at the RAN 39 level with an off load capability. The applications which may be supported by the architecture may have distributed and centralized components.

The network architecture broadly comprises a radio access side 32 and a mobile packet core 34. The radio access side comprises user equipment 1. The user equipment are configured to communicate with a respective radio access network. In FIG. 1, first, second and third radio access networks 39 are shown. Each RAN may comprise one or more access nodes. The access nodes may comprise any suitable access node. Depending on the standard involved, the access node may be a base station such as a node B with at least some RNC functionality or an enhanced node B. The latter refers to the Long Term Evolution (LTE) of the Universal Mobile Telecommunications System (UMTS) standardised by 3GPP (Third Generation Partnership Project). A controller for the base stations may be provided. In some standards, the controller may be a radio network controller. The radio network controller is able to control the plurality of base stations. In other embodiments, a distributed control function is provided and each base station incorporates part of that control function.

Each of the RAN shown in FIG. 1 is provided with a server such as an application server function. The application server function 38 may be provided by a separate entity or may be integrated with one or more other entities.

The application server function may be integrated with a base station 39 having at least some RNC functionality and/or RNC or any other type of controller. It should be appreciated that other embodiments are additionally or alternatively envisaged such as where server functionality is integrated into a node of the RAN, for example the RNC or the base station having for example RNC functionality. In some embodiments, a physical realisation would be a RNC/base station plus server in a same integrated hardware. In some embodiments the physical realisation or hardware may be different. A physical realization may be different (for example an integrated one), even though the software functionality may be the same or similar, in some embodiments.

The mobile packet core 34 comprises mobile gateway node 46 and 48. The mobile gateway may be a GGSN (gateway GPRS (General Packet Radio Service) support node) and the mobile gateway 48 may be a (PGW) packet gateway. These gateways are by way of example. One or more other types of gateway may additionally or alternatively be provided in different embodiments. Only one type of gateway may be provided in some embodiments. More than one type of gateway may be provided in other embodiments.

The mobile packet core 34 also comprises a mobile network control part 54. This part comprises SGSNs (serving GPRS Support Node) and MMEs (mobile management entities) entities 56 and 58.

In some embodiments, the mobile packet core 34 may comprise a function 60. This function may provide one or more of a lawful intercept function which allows authorised authorities to monitor communications, policy control function and charging control function. One or more of these functions may be provided separately and/or in different combinations.

The radio access part 32 is able to communicate with the mobile packet core via connectivity and transport function 62.

The application server function 38 may host applications, which can be accessed by subscribers via leaky bearer traffic offload. For example, a subscriber can access applications hosted by the server 38 via the offload of respective IP flows of the subscriber's mobile bearer to the corresponding application.

Some embodiments may enable the operator to control the local access to applications per subscriber and mobile bearer based on defined policy rules. Some embodiments may address one or more of the following:
In 3GPP network architecture, the RAN is not part of the policy control and charging (PCC) architecture, i.e. there are no RAN interfaces to the PCC.
The subscriber population in a BTS/application server function cell coverage area can change vary rapidly, i.e. subscribers moving in and out of the cell area or changing between active and idle state frequently. Storing individual static local access policy rule configuration at the application server function for every subscriber, who might visit the respective cell may not be appropriate.
In a LTE eNB, there is no permanent subscriber identity available. This may make it difficult to identify the subscriber and directly request per subscriber policy rules from an external policy server.
The UE IP address, which is visible at RAN, may be used to identify the subscriber. UE IP address ranges are reused at different APNs (access point names) of the mobile network. Therefore the same IP address may be allocated at the same time to different UEs and therefore is not subscriber specific.
A subscriber may have multiple active mobile bearers connected to different mobile GWs (GGSNs, PGWs) and APNs. There is neither in LTE nor in 3G information available at the RAN side to which APN and mobile GW the respective mobile bearer is connected. To request and apply access policy rules per subscriber and mobile bearer would require this information.
In 3G the IMSI (international mobile subscriber identity) is available at the BTS having RNC functionality. This may allow the request of policy rules per subscriber from an external policy server. However policy servers today are not prepared to handle thousands of BTS sites and frequent requests due to mobility. For example a new request may be generated whenever a moving subscriber enters a different application server function equipped cell area.
Some embodiments may be applied to more than one access technology. For example, some embodiments may be applied to LTE and 3G. However some embodiments may be used with only one access technology. Other embodiments may be used with two or more access technologies. LTE and 3G are two examples and some embodiments may alternatively or additionally be used with one or more other technologies.
Some embodiments may be access technology independent.
Some embodiments may be implemented with a small impact on 3GPP architecture and interfaces.

An embodiment will now be described in relation to FIG. 2. A user equipment 1 is configured to communicate with a RAN comprising an eNB 39 and/or RNC.

The application server function may be provided as part of the RAN. For example, the application server function may be integrated with the RAN. The application server function may communicate with the network via the RAN node. Alternatively or additionally, the application server function may be provided between the Radio Access Node and mobile packet core.

The mobile packet core gateway(s) shown in FIG. 2 comprise a SGW (serving gateway) and PGW for an LTE implementation, or SGSN and/or GGSN for a 3G implementation. It should be appreciated that in some embodiments, the mobile gateways may be provided to support LTE and 3G. In some embodiments alternatively or additionally, other standards may be supported.

A Policy Mediator (POL-M) 54 is connected to the SGi interface (in LTE) or Gi (in 3G) interface of the respective mobile packet gateway.

A policy server 52 is provided which may be a standardized network element or a non-standardized network element. The policy server may be provided by one or more of a PCRF (policy and charging rules function), a Radius server, or a plain policy database like an LDAP (lightweight directory access protocol) server.

The POL-M 54 may optionally implement a Radius server, providing Radius accounting for a mobile packet gateway (PGW or GGSN), or a policy server (PCRF). The policy mediator and the policy server may be provided by the same or different entities.

In some embodiments, at the time of activation or modification of a PDN (packet data network) connection some embodiments may provide the following function. In some embodiments, the Policy Mediator (POL-M) 54 is located on the SGi side of the PGW 48. The POL-M connects to one or more APN IP subnets of one or more PGWs 48. In some embodiments, APNs may use overlapping IP subnets. The POL-M 54 may have multiple ports or for example implement Virtual Routing Functions so as to be able to connect two or more APN subnets that may have overlapping IP subnet addresses. Virtual Routing Functions is a routing functionality supported e.g. by IP routers, which enables the use of overlapping IP address ranges in an IP network. GGSN and PGWs support this functionality. The UE IP address is assumed to be unique within an APN.

As an initial step, the POL-M 54 needs to be aware of a new or modified PDN connection. This would be a PDP context in 3G. One way to realise this may be as follows. The PGW 48 uses POL-M 54 as a radius accounting server. The message flow in relation to this embodiment will be described in relation to FIG. 3.

It should be appreciated that FIG. 3 is a simplified example. In other embodiments, alternatively or additionally different types of bearer establishment may be used.

In step S1 a PDP context or bearer request is created. For example in a 3G situation this may be a PDP context and in LTE this may be an EPS (evolved packet system) bearer. This involves signalling between the UE 1 and the mobile network. This may include one or more of eNB, MME and S-/PGW.

When the mobile bearer is established at the PGW 48, the PGW will send an access request message to the POL-M 54 in step S2. This message comprises a subscriber's IMSI and the corresponding mobile bearer's IP address. This message may alternatively or additionally comprise other parameters such as the IMEI.

In one alternative, the PCRF may push policy for a given IP address to the POL-M upon establishment or modification of a PDN connection.

In step S3, the POL-M 54 requests policy information from the PCRF.

In step S4, the policy is downloaded from the PROF to the POL-M 54. In this way the POL-M retrieves the application server function specific policy for the subscriber from a policy server or policy rule database using the IMSI received in the previous step. Alternatively or in addition, the IMEI can be used to retrieve the appropriate policy. In this embodiment, the policy server is the PROF but the policy server can be any other suitable server. In some embodiments a standard policy interface or simple LDAP database access can be used.

Alternatively or additionally, the PGW can provide the policy rule base name as part of the messaging. The messaging may be radius accounting messaging. In this case an additional policy interface and steps S3 and S4 may be omitted.

Alternatively or additionally the POL-M may have pre-configured policy defined per for example APN and optionally one or more parameters provided in the Access-Request message.

In step S5, an access accept message is sent by the POL-M 54 to the PGW. This message is used to confirm the access request message receipt and processing.

In step S6, PGW 48 accepts the create PDP context/bearer request and the UE 1 may be informed via the SGW and MME.

At the time a user flow becomes active at an application server function node 38, either due to mobility into the coverage area of an application server function or activation of RAB (radio access bearer)/eRAB, the UE IP address becomes visible for the application server function. The application server function will send a policy query in the established GTP-U (GPRS tunnelling protocol user plane) tunnel to the POL-M 54 to retrieve the policy valid for the UE IP address. This is step S7. The GTP-U tunnel may be established between the eNB and the SGW and PGW. One or more options may be used for the query. Any one or more of the following query concepts can be used.
The query can be a DNS (domain name server) query to resolve an UE IP address to a policy rule base name, which is preconfigured at the application server function. In this case POL-M would work as a DNS server.
POL-M could also operate as a “WEB-server”, in which case RACs would issue a http get request to the POL-M.

By sending the query inside the GTP-U tunnel of the mobile bearer, the query reaches the correct PGW, related APN and corresponding POL-M. The POL-M can differentiate between APNs of the PGW e.g. based on source network interface or Ethernet VLAN and therefore can map the received UP IP address uniquely to the corresponding IMSI and corresponding access policy rule database.

In step S8, the POL-M responds with the respective policy rules to the application server function. The application server function offloads the packets based on for example suitable filters. For examples, the filters may be IP 5-tuple filters. For example filtering may be based on at least one and in some embodiments all of: destination IP address; source IP addresses, destination port number, source port number, and protocol (for example TCP (transmission control protocol) or UDP (User datagram protocol) or the like). The application server function 38 extracts the policies and applies them for application access.

In some embodiments, the query and/or response of steps S7 and S8 can be excluded from charging in PGW based on the filtering—for example IP 5-tuple, i.e. one or more of IP addresses, port numbers, transport protocol, in order to avoid billing user for traffic he has not generated. The charging function in a packet core may be configured to exclude the queries from charging. This is may use functionality at the PGW which makes it possible to include/exclude traffic flows from charging. In this case IP traffic to and/or from the POL-M would be excluded from charging.

In some embodiments, steps S7 and S8 may be repeated each time there is a new application server function access. This means that once the policy has become available at POL-M at EPS bearer set-up, that policy will be stored in the POL-M. When the UE moves to a new eNB with integrated application server function (due to for example mobility, or handover) or changes from an idle to active state only steps S7 and S8 may have to be repeated.

In some embodiments, no subscriber sensitive information (e.g. IMSI, subscription information, charging records) need be handled at the eNB/application server function side.

In embodiments, different access policy rule set retrieval variations are possible. Some embodiments may use one or more of statically configured policy at the application server function 38 and the application server function retrieves the policy rule base names from the POL-M. Alternative embodiments may use other alternatives such as retrieving the explicit policy rules from the POL-M.

For statically configured policy at the application server function a set of policy rule bases are preconfigured at the application server function. The POL-M will respond to the application server function policy query with the policy rule name, which will be activated for the corresponding mobile bearer. In other words the rule or rules itself are stored in the application server function and the POL-M will provide information identifying the one or more rules which apply to the particular UE. The POL-M may have the policy rule set names per subscriber available once the mobile bearer has been established. The policy rule base name for a specific mobile bearer may be sent by the PGW as part of the radius accounting message or any other suitable message, when the mobile bearer is established. Alternatively or additionally, the POL-M fetches the respective policy rule base name at mobile bearer establishment from a policy server or policy rule database (e.g. policy interface, LDAP).

For the application server function retrieving policy rules from POL-M, the policy query response from POL-M to the application server function would contain a full rule set to be applied for the EPS or PDN connection, depending on the standard. The rule may be resolved in different ways in the same or different embodiments. For example, the POL-M may have rule sets statically configured, and the selection is done per rule set name assigned for the subscriber as above in the statically configured cases. Alternatively or additionally, the POL-M may obtain rule set from the PCRF (policy server) over the Gx interface.

There may be a number of different mechanisms to implement an in-band policy query, that is steps S7 and S8 of FIG. 3. The query mechanism may utilize a connection-less protocol, such as a DNS query. The POL-M would work as a DNS server, resolving the UE IP address and APN to the respective policy rule base name. The DNS protocol is UDP based, which enables fast query-response cycles and high query-response rates.

The query mechanism could alternatively or additionally utilize connection-oriented TCP transport and use the commonly used http protocol to transfer the query and response. This may be using for example Web Services or the REST paradigm, where the POL-M would act as a HTTP server. Alternatively or additionally, the query mechanism may use a custom protocol on top of the TCP.

Some embodiments may provide solutions to potential security threats. For example in some embodiments, mobile stations (UEs) may not be permitted to make queries or access the policy server. Even though a query response from POL-M would not contain sensitive information, preventing direct UE access may improve security. In some embodiments, TLS (Transport Layer Security) is used with authentication of clients. In this option, the POL-M may check the identity of application server function based on certificates. In some embodiments, PKI (public key infrastructure) may be additionally or alternatively used to make POL-M very safe from the authentication point of view. It may be avoided that any other entity other than the application server function can query the POL-M. The POL-M should therefore be sure that query comes from application server function and not from UE. The in-band query from the application server function to POL-M uses the UE IP address as identifier. Accordingly, in some embodiments authentication of the query sender is required.

Alternatively or additionally, authenticated and optionally integrity protected packets may be used in the communication between application server function and the POL-M. Examples of authenticated packets may be IPSec authenticated header (AH) or ESP (encapsulated security payload).

In some embodiments, internet clients may be prevented from querying the POL-M. In some embodiments, this may be facilitated by allocating a private IP address for POL-M which is not accessible from Internet. Additionally or alternatively, cryptographic authentication using TLS as above with authentication of clients provides access protection from computers residing within the private address space.

Authentication and encryption may also be implemented on an application protocol level instead of network (IPSec) or transport layer security (TLS). Such solution may utilize PKI (public key information) and authentication and integrity protection algorithms as the mentioned standardized protocols.

In some embodiments to prevent denial of service (DoS) from the Internet, access control lists (ACLs) may be provided in for example firewalls, preventing internet nodes from reaching the POL-M address (es). The firewalls may be provided at the border of the operator's network with the Internet. In this way packets to POL-M from the Internet can be prevented.

In some embodiments, to prevent denial of service (DoS) from UEs, one mechanism may be to prevent UE's IP access to POL-M address (es). This is possible with a leaky bearer breakout node such as an application server function, which would be able to do filtering within a GTP-U tunnel and drop packets targeted to POL-M. The Mobile gateway cannot detect whether the sender is the application server function or UE, because application server function is spoofing—i.e. sending requests using UE's IP address. This mechanism requires that the BTS is connected through an application server function.

Another mechanism to prevent DoS from the UE is to authenticate messages below the connection oriented layer (TCP) as DoS attacks often target TCP layer where only a limited number of connections is supported. One or more different alternatives may be possible. For example, some embodiments may use IPSec, either with authenticated header (AH) or ESP (encapsulated security payload).

Some embodiments may verify the authenticity of the POL-M. The application server function may need to verify the authenticity of the POL-M to know that a returned policy can be trusted. One or more cryptographic mechanisms may be used. For example TLS with checking of server certificate may be used, IPSec AH or ESP or DNSsec where the DNS reply can be authenticated. These are by way of example only and any suitable technology enabling the application server function to securely verify that the received policy comes from a POL-M may be used.

In some embodiments, for UEs with frequent state changes between active and idle within the same application server function coverage area, the policy rules can be stored locally for a configurable time to be reused when the UE changes between active and idle and back. This avoids a “policy query storm” towards the POL-M. The application server function may have to match a UE and bearer with a previous session.

Storing pairs of temporary UE Identities and IP address with a predefined time to live or period of validity and checking the re-appearance of these provides one option for caching policy rules which may have a low likelihood of collision.

During the policy query phase there may be already UE user data passing in the uplink or downlink direction but before the policy response has been received. For this period a default policy per application may be locally configured, i.e. access to application allowed or forbidden. For example, for locally terminated application traffic flows, the offloaded user plane can be buffered until the policy query response has been received. The traffic flows for pass-through applications may not be offloaded. Traffic or control plane analytics applications without a per subscriber context may have a default static access policy

In a cellular network, UE's may hand off from one base station to another at any time. Due to this, there is possibility that after a policy query was sent from a breakout point (source application server function), the UE is handed off to another base station which is connected to another (target) application server function or to a base station not connected to any application server function

The action taken in relation to a misrouted reply in each of the above two cases may depend on the protocol and/or security measures. For example, if a connection oriented (TCP) protocol is used, a misrouted reply is by default discarded in both cases by the TCP stack of receiver. If payload security is used (TLS or IPSec ESP), the target (application server function or UE) is not able to decode content of the reply. The new (target) application server function will send a query of its own and receive policy rules or information.

In some embodiments, connectionless transport protocol like UDP may be used between POL-M and application server, in conjunction with “out-of-band” return path for the reply packets from POL-M to the application server. In such arrangement, the in-band query from the application server could contain a return address through the out-of-band network. In this embodiment, it would not be possible that a reply from the POL-M ends up accidentally with a UE.

Reference is made to FIG. 4 which schematically shows an application server function. In FIG. 4, the RAN 39 is in communication with a Gateway 324 via the application function 38. It should be appreciated that the Gateway function 324 may be provided in the packet core. The gateway 324 may allow connections to networks such as the Internet or the like. The application server function 38 is schematically shown. A connection, for example in the form of the PDP context or radio access bearer 304 extends between the RAN and gateway and may be in either or both directions. For simplicity, a single connection 304 is shown. The data on the connection provided by the RAN or the gateway is intercepted by an off load router block 301. The data may for example be in the form of packets.

The packets are then provided to an off load function 312 of the offload router. The offload function may implement selective offload using for example an appropriate filter rule set. The rules may be matching rules and may for example look at the header of each packet. Depending on the result of the filtering or the like of the offload function 312, packets may be routed to an appropriate application. In this example, two applications are shown, application 1 and application 2. However, it should be appreciated that the number of applications provided may be more or less than two. The application may provide any suitable function.

The traffic which is not to be off loaded is passed through. The packets which are to be offloaded may be subject to address translation at address translator 310. For example, the address translator 310 may translate the user equipment address into an address which is used by an application in a virtual network domain in the application server function. The address translator 310 may provide a translation function on a packet when it has been offloaded and before the packet is directed to an appropriated application. The address translator 310 will reverse the address translation for packets which are provided by the respective application back to the carried out on the input side.

It should be appreciated that in some embodiments the arrangement is bidirectional. Accordingly, packets provided by the gateway 324 will be input to the off load router 301 and may be offloaded to one or more of the applications. One or more of the applications may provide an output which is routed back to the offload router. The offload router and in particular the offload function 312 will control the routing of those packets. In some embodiments, the offload routing function 312 may route information from applications to the radio access network or back to the gateway. Packets provided by the RAN 39 will be input to the off load router 301 and may be offloaded to one or more of the applications. One or more of the applications may provide an output which is routed back to the offload router. The offload router and in particular the offload function 312 will control the routing of those packets. In some embodiments, the offload routing function 312 may route information from applications to the gateway or back to the RAN.

An appropriately adapted computer program code product or products may be used for implementing some embodiments, when loaded on an appropriate data processing apparatus, for example for determining geographical boundary based operations and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is also noted herein that while the above describes exemplifying embodiments of the invention, there are several variations and modifications which may be made to the disclosed solution without departing from the scope of the present invention.

1.-25. (canceled)

26. A method comprising:
sending a request from an application server functionality;
at a policy server functionality, providing a local application functionality to a user equipment, said policy server functionality storing local application policy information for said user equipment; and
receiving information from said policy server functionality about said local application policy information for said user equipment.

27. A method as claimed in claim 26, wherein said information about said local application policy information for said user equipment comprises one or more rules to be applied to said user equipment.

28. A method as claimed in claim 26, wherein said information about said local application policy information for said user equipment comprises information identifying one or more rules stored in said application server functionality.

29. A method as claimed in claim 26, wherein said application server functionality is provided in a radio access network.

30. A method as claimed in claim 26, comprising storing said information from said policy server functionality about said local application policy information for said user equipment information in said application server functionality.

31. A method as claimed in claim 30, wherein said stored information has a validity period associated therewith.

32. A method comprising:
receiving a request from an application server functionality;
providing a local application functionality to a user equipment, at a policy server functionality, said policy server functionality storing local application policy information for said user equipment; and
providing information from said policy server functionality to said application server functionality about said local application policy information for said user equipment.

33. A method as claimed in claim 32, wherein the information about said local application policy information for said user equipment comprises one or more rules to be applied to said user equipment.

34. A method as claimed in claim 32, wherein the information about said local application policy information for said user equipment comprises information identifying one or more rules stored in said application server functionality.

35. A method as claimed in claim 32, comprising using tunnelling between said application server and said policy server functionality to communicate at least one of said request and said information therebetween.

36. A method as claimed in claim 35, comprising using tunnelling between said application server and said policy functionality to communicate one of said request and said information therebetween and a different path to communicate the other of said request and information between the application server and said policy functionality.

37. A method comprising:
receiving, at a policy server functionality, identity information associated with a user equipment: and
responsive to said information obtaining from a further entity policy information for said user equipment.

38. A method as claimed in claim 37, wherein said further entity comprises one or more of a PCRF, a radius server, a database and an LDAP server.

39. A method as claimed in claim 37, wherein said identity information comprises an IMSI and/or IP address.

40. An apparatus comprising at least one processor and at least one memory including computer code for one or more programs, the at least one memory and the computer code configured, with the at least one processor, to cause the apparatus at least to:
send a request from an application server functionality;
providing a local application functionality to a user equipment, at a policy server functionality, said policy server functionality storing local application policy information for said user equipment; and
receive information from said policy server functionality about said local application policy information for said user equipment.

41. An apparatus as claimed in claim 40, wherein the information about said local application policy information for said user equipment comprises one or more rules to be applied to said user equipment.

42. An apparatus as claimed in claim 40, wherein the information about said local application policy information for said user equipment comprises information identifying one or more rules stored in said application server functionality.

43. An apparatus as claimed in claim 40, wherein the at least one memory and the computer program code are configured to, with the at least one processor to store said information from said policy server functionality about said local application policy information for said user equipment information in said application server functionality.

44. An apparatus as claimed in claim 40, wherein the at least one memory and the computer program code are configured to, with the at least one processor to use tunnelling between said application server and said policy server functionality to communicate at least one of said request and said information therebetween.

45. An apparatus as claimed in claim 44, wherein the at least one memory and the computer program code are configured to, with the at least one processor to use tunnelling between said application server and said policy functionality to communicate one of said request and said information therebetween and a different path to communicate the other of said request and information between the application server and said policy functionality.
